(19) United States
(12) Patent Application Publication
(10) Pub. No.: US 2022/0208187 A1
(43) Pub. Date: Jun. 30, 2022

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventor: Kazuya Watanabe, Tokyo (JP)

(21) Appl. No.: 17/560,425

(22) Filed: Dec. 23, 2021

(30) Foreign Application Priority Data
Dec. 28, 2020 (JP) 2020-218449

(51) Int. Cl. G10L 15/22

(52) U.S. Cl. CPC G10L 15/22; G10L 2015/225; B60R 16/0373; G10L 2015/221; G10L 2015/228

(57) ABSTRACT

An information processing device of an embodiment includes a determiner configured to determine priority of metadata on the basis of an importance level indicating a degree of importance a user to each of a plurality of pieces of content and an amount of information of the metadata that is attached to each of the plurality of pieces of content and a notifier configured to notify the user of the metadata on the basis of the priority determined by the determiner.

### CROSS-REFERENCE TO RELATED APPLICATION

This application is based upon and claims the benefit of priority from Japanese Patent Application No. 2020-218449, filed Dec. 28, 2020, the entire content of which is incorporated herein by reference.

### BACKGROUND

### Field of the Invention

The present invention relates to an information processing device, an information processing method, and a storage medium.

### Description of Related Art

A voice user interface using speech recognition technology and its related technology are known (see, for example, Japanese Unexamined Patent Application, First Publication No. 2020-80110, Japanese Unexamined Patent Application, First Publication No. 2017-220238, and Japanese Unexamined Patent Application, First Publication No. 2020-30489).

### SUMMARY

However, in the conventional technology, there may be excess or deficiency in information to be provided to the user in a notification via a voice user interface.

Aspects of the present invention have been made in consideration of such circumstances and an objective of the present invention is to provide an information processing device, an information processing method, and a storage medium capable of making an adjustment to an amount of information suitable for each user with respect to information to be provided to the user in a notification via a voice user interface.

An information processing device, an information processing method, and a storage medium according to the present invention adopt the following configurations.

(1) According to a first aspect of the present invention, there is provided an information processing device including: a determiner configured to determine priority of metadata on the basis of an importance level indicating a degree of importance a user to each of a plurality of pieces of content and an amount of information of the metadata that is attached to each of the plurality of pieces of content; and a notifier configured to notify the user of the metadata on the basis of the priority determined by the determiner.

(2) According to a second aspect of the present invention, the information processing device according to the first aspect further includes: an acquirer configured to acquire a request from an utterance of the user; and an extractor configured to extract the metadata from one or more pieces of the content satisfying the request acquired by the acquirer, wherein the determiner determines the priority of the metadata on the basis of an amount of information of the metadata extracted by the extractor and the importance level of the content to which the metadata extracted by the extractor is attached, and wherein the notifier notifies the user of the metadata as a response to the request on the basis of the priority.

(3) According to a third aspect of the present invention, the information processing device according to the second aspect further includes an estimator configured to estimate the importance level on the basis of a surrounding environment of the user when the user makes an utterance of the request.

(4) According to a fourth aspect of the present invention, in the information processing device according to the third aspect, the estimator further estimates the importance level on the basis of a result of feedback of the user provided in response to a notification of the metadata.

(5) According to a fifth aspect of the present invention, in the information processing device according to any one of the first to fourth aspects, the metadata includes text, and the notifier notifies the user of the metadata by reading the text included in the metadata by automatic speech.

(6) According to a sixth aspect of the present invention, in the information processing device according to the fifth aspect, the determiner determines the priority of the metadata so that the reading of the text is completed within a period until the user reaches a destination.

(7) According to a seventh aspect of the present invention, in the information processing device according to any one of the first to sixth aspects, the determiner raises the priority of the metadata for which the importance level for the content of an attachment destination is high and the amount of information is small.

(8) According to an eighth aspect of the present invention, in the information processing device according to any one of the first to seventh aspects, the user is a driver who drives a vehicle and the determiner further determines the priority of the metadata on the basis of a driving load on the driver.

(9) According to a ninth aspect of the present invention, in the information processing device according to the eighth aspect, the determiner lowers the priority of the metadata whose amount of information increases as the driving load on the driver increases.

(10) According to a tenth aspect of the present invention, in the information processing device according to the eighth or ninth aspect, the notifier notifies the user of more metadata when the vehicle is under an automated driving mode as compared with when the vehicle is under a manual driving mode.

(11) According to an eleventh aspect of the present invention, in the information processing device according to any one of the eighth to tenth aspects, the notifier further notifies the user of the content when the vehicle is under an automated driving mode.

(12) According to a twelfth aspect of the present invention, there is provided an information processing method including: determining, by a computer, priority of metadata on the basis of an importance level indicating a degree of importance a user to each of a plurality of pieces of content and an amount of information of the metadata that is attached to each of the plurality of pieces of content; and notifying, by the computer, the user of the metadata on the basis of the determined priority.

(13) According to a thirteenth aspect of the present invention, there is provided a computer-readable non-transitory storage medium storing a program for causing a computer to: determine priority of metadata on the basis of an importance level indicating a degree of importance a user to each of a plurality of pieces of content and an amount of information of the metadata that is attached to each of the plurality of pieces of content; and notify the user of the metadata on the basis of the determined priority.

According to the above aspect, an adjustment to an amount of information suitable for each user can be made with respect to information to be provided to the user in a notification via a voice user interface.

### BRIEF DESCRIPTION OF THE DRAWINGS

FIG. 1 is a configuration diagram of an information providing system of an embodiment.

FIG. 2 is a diagram for describing content of user authentication information.

FIG. 3 is a configuration diagram of a communication terminal of the embodiment.

FIG. 4 is a diagram showing an example of a schematic configuration of a vehicle equipped with an agent device of the embodiment.

FIG. 5 is a flowchart showing a flow of a series of processing steps of an information providing device of the embodiment.

FIG. 6 is a diagram showing an example of a viewpoint list.

FIG. 7 is a diagram showing an example of an importance level list.

FIG. 8 is a diagram showing an example of point of interest (POI) information.

FIG. 9 is a diagram showing an example of a metadata list.

FIG. 10 is a diagram showing an example of a list with an importance level viewpoint.

FIG. 11 is a diagram showing an example of priority of metadata.

FIG. 12 is a diagram showing an example of a response sentence.

FIG. 13 is an example of a scene to which technology of the present embodiment is applied.

FIG. 14 is a diagram showing an example of information provided to a user.

FIG. 15 is a diagram showing an example of information provided to the user.

FIG. 16 is a diagram showing another example of a schematic configuration of a vehicle equipped with the agent device of the embodiment.

### DESCRIPTION OF EMBODIMENTS

Hereinafter, embodiments of an information processing device, an information processing method, and a storage medium of the present invention will be described with reference to the drawings.

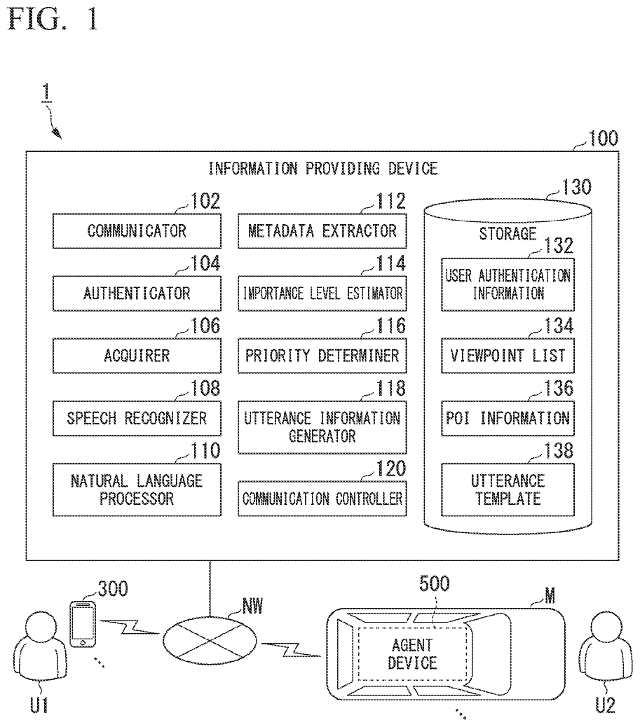

FIG. 1 is a configuration diagram of an information providing system 1 of the embodiment. The information providing system 1 includes, for example, an information providing device 100, a communication terminal 300 used by a user U1 of the information providing system 1, and a vehicle M used by a user U2 of the information providing system 1. These components can communicate with each other via a network NW. The network NW includes, for example, the Internet, a wide area network (WAN), a local area network (LAN), a telephone circuit, a public circuit, a dedicated circuit, a provider device, a radio base station, and the like. The information providing system 1 may include a plurality of communication terminals 300 and/or a plurality of vehicles M. The vehicle M includes, for example, an agent device 500. The information providing device 100 is an example of the “information processing device.”

The information providing device 100 receives an inquiry or a request of the user U1 or the like from the communication terminal 300, performs a process according to the received inquiry or request, and transmits a processing result to the communication terminal 300. Also, the information providing device 100 receives an inquiry or request of the user U2 or the like from the agent device 500 mounted in the vehicle M, performs a process according to the received inquiry or request, and transmits a processing result to the agent device 500. The information providing device 100 may function as, for example, a cloud server that communicates with the communication terminal 300 and the agent device 500 via the network NW and transmits and receives various types of data.

The communication terminal 300 is, for example, a portable terminal such as a smartphone or a tablet terminal. The communication terminal 300 receives information of an inquiry, a request, or the like from the user U1. The communication terminal 300 transmits the information received from the user U1 to the information providing device 100 and outputs information obtained as a response to the transmitted information. That is, the communication terminal 300 functions as a voice user interface.

The vehicle M in which the agent device 500 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power with which a secondary battery or a fuel cell is discharged. The vehicle M may be an automated driving vehicle. The automated driving is, for example, automatically controlling one or both of the steering or the speed of the vehicle. The driving control of the vehicle described above may include, for example, various types of driving control such as adaptive cruise control (ACC), auto lane changing (ALC), and lane keeping assistance system (LKAS). In the automated driving vehicle, driving may be controlled according to the manual driving of an occupant (a driver).

The agent device 500 interacts with the occupant of the vehicle M (for example, the user U2) or provides information for an inquiry or a request from the occupant or the like. The agent device 500 receives, for example, information of an inquiry or a request from the user U2 or the like, transmits the received information to the information providing device 100, and outputs information obtained as a response to the transmitted information. Like the communication terminal 300, the agent device 500 functions as the voice user interface. A combination of the voice user interface (the communication terminal 300 or the agent device 500) and the information providing device 100 is another example of the “information processing device.”

### [Information Providing Device]

Hereinafter, a configuration of the information providing device 100 will be described. The information providing device 100 includes, for example, a communicator 102, an authenticator 104, an acquirer 106, a speech recognizer 108, a natural language processor 110, a metadata extractor 112, an importance level estimator 114, a priority determiner 116, an utterance information generator 118, a communication controller 120, and a storage 130. A combination of the acquirer 106, the speech recognizer 108, and the natural language processor 110 is an example of an “acquirer.” The metadata extractor 112 is an example of an “extractor,” the importance level estimator 114 is an example of an “estimator,” and the priority determiner 116 is an example of a “determiner.” A combination of the communicator 102, the utterance information generator 118, and the communication controller 120 or a combination of the communicator 102, the utterance information generator 118, the communication controller 120, and the voice user interface is an example of a “notifier.”

Each of the authenticator 104, the acquirer 106, the speech recognizer 108, the natural language processor 110, the metadata extractor 112, the importance level estimator 114, the priority determiner 116, the utterance information generator 118, and the communication controller 120 is implemented by, for example, a hardware processor such as a central processing unit (CPU) executing a program (software). Some or all of these components may be implemented by hardware (including a circuit; circuitry) such as a large-scale integration (LSI) circuit, an application-specific integrated circuit (ASIC), a field-programmable gate array (FPGA), or a graphics processing unit (GPU) or may be implemented by software and hardware in cooperation. The program may be pre-stored in a storage device (a storage device including a non-transitory storage medium) such as a hard disk drive (HDD) or a flash memory or may be stored in a removable storage medium (a non-transitory storage medium) such as a DVD or a CD-ROM and installed in the storage device of the information providing device 100 when the storage medium is mounted in a drive device or the like.

The storage 130 is implemented by the above-mentioned various types of storage devices, an electrically erasable programmable read-only memory (EEPROM), a read-only memory (ROM), a random-access memory (RAM), or the like. In addition to the program referred to by the processor, the storage 130 stores, for example, user authentication information 132, a viewpoint list 134, point of interest (POI) information 136, an utterance template 138, and the like.

The user authentication information 132 includes, for example, information for identifying a user who uses the information providing device 100, information used at the time of authentication by the authenticator 104, and the like. The user authentication information 132 is, for example, a user ID, a password, an address, a name, an age, a gender, a hobby, a special skill, and other information. The other information includes the user's hobbies, special skills, interests, and the like.

The viewpoint list 134 is data in which a plurality of viewpoints in which the user may be interested are listed. The plurality of viewpoints may be determined by the user's self-report or a representative one may be statistically selected from report results of a plurality of users.

The POI information 136 is information about a specific point such as a store or a facility. The POI information 136 includes content related to a POI, metadata associated with the content, and the like.

The utterance template 138 is a template (a standard format) when a response sentence to be described below is generated.

### [Description of Components]

Hereinafter, each component of the information providing device 100 will be described. The communicator 102 is an interface for communicating with the communication terminal 300, the agent device 500, and other external devices via the network NW. For example, the communicator 102 includes a network interface card (NIC), an antenna for wireless communication, and the like.

The authenticator 104 registers information about users (for example, the users U1 and U2) who use the information providing system 1 as user authentication information 132 in the storage 130. For example, when a user registration request has been received from the voice user interface (the communication terminal 300 or the agent device 500), the authenticator 104 causes a device from which the registration request has been received to display a graphical user interface (GUI) for inputting various types of information included in the user authentication information 132. When the user inputs various types of information to the GUI, the authenticator 104 acquires information about the user from the device. The authenticator 104 registers the information about the user acquired from the voice user interface (communication terminal 300 or the agent device 500) as the user authentication information 132 in the storage 130.

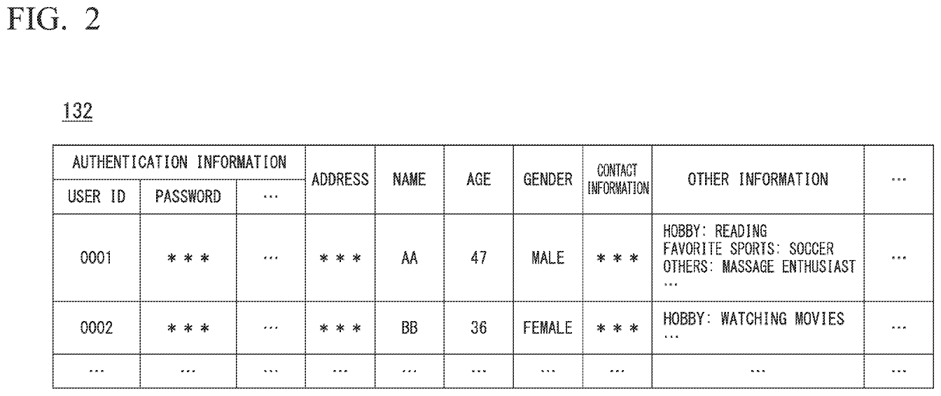

FIG. 2 is a diagram for describing content of the user authentication information 132. In the user authentication information 132, for example, information such as an address, a name, an age, a gender, contact information, and other information of the user is associated with the user's authentication information. The authentication information includes, for example, a user ID, a password, and the like, which are identification information for identifying the user. Also, the authentication information may include biometric information such as fingerprint information and iris information. The contact information may be, for example, address information for communicating with the voice user interface (the communication terminal 300 or the agent device 500) used by the user, or may be a telephone number, an e-mail address, terminal identification information, or the like of the user. The information providing device 100 communicates with various types of mobile communication devices on the basis of the contact information and provides various types of information.

The authenticator 104 authenticates a user of a service of the information providing system 1 on the basis of the user authentication information 132 registered in advance. For example, the authenticator 104 authenticates the user at a timing when a service use request has been received from the communication terminal 300 or the agent device 500. Specifically, when the use request has been received, the authenticator 104 causes a terminal device, which has transmitted the request, to display a GUI for inputting authentication information such as a user ID or a password and compares the input authentication information input to the GUI with authentication information of the user authentication information 132. The authenticator 104 determines whether or not the authentication information matching the input authentication information has been stored in the user authentication information 132 and allows the use of a service when the authentication information matching the input authentication information has been stored. On the other hand, when the authentication information matching the input authentication information has not been stored, the authenticator 104 performs a process of prohibiting the use of the service or causing new registration to be performed.

The acquirer 106 acquires utterances of one or more users from the communication terminal 300 or the agent device 500 via the communicator 102 (via the network NW). The user's utterance may be speech data (also referred to as sound data or a sound stream) or may be text data recognized from the speech data.

The speech recognizer 108 performs speech recognition for recognizing the user's utterance speech (a process of textualizing speech). For example, the speech recognizer 108 performs speech recognition on speech data representing the user's utterance acquired by the acquirer 106 and generates text data obtained by textualizing the speech data. The text data includes a string in which content of the utterance is written as text.

For example, the speech recognizer 108 may textualize speech data using a sound model and a dictionary for automatic speech recognition (ASR) (hereinafter referred to as an ASR dictionary). The sound model is a model that is pre-learned or adjusted so that input speech is separated in accordance with a frequency and each element of the separated speech is converted into a phoneme (a spectrogram) and is, for example, a neural network, a hidden Markov model, or the like. The ASR dictionary is a database in which a string is associated with a combination of a plurality of phonemes and a position for separating the string is defined by a syntax. The ASR dictionary is a so-called pattern matching dictionary. For example, the speech recognizer 108 inputs speech data to a sound model, searches the ASR dictionary for a set of phonemes output by the sound model, and acquires a string corresponding to the set of phonemes. The speech recognizer 108 generates a combination of strings obtained as described above as text data. Also, instead of using the ASR dictionary, the speech recognizer 108 may generate text data from an output result of the sound model using, for example, a language model implemented by an n-gram model or the like.

The natural language processor 110 performs natural language understanding to understand a structure or a meaning of text. For example, the natural language processor 110 interprets a meaning of the text data generated by the speech recognizer 108 with reference to a dictionary (hereinafter, a natural language understanding (NLU) dictionary) provided in advance for semantic interpretation. The NLU dictionary is a database in which abstract semantic information is associated with text data. The NLU dictionary may include a synonym, a quasi-synonym, and the like. Speech recognition and natural language understanding do not necessarily have to be separated as distinct stages and may affect each other in a process of receiving a result of natural language understanding and modifying a result of speech recognition or the like.

When the meaning of the user's utterance understood by the natural language processor 110 is a “request,” the metadata extractor 112 extracts metadata of one or more pieces of content satisfying the “request” from the POI information 136. For example, it is assumed that a user makes the utterance “Find a nearby Chinese restaurant” as the “request” with respect to a voice user interface and this request is understood by the natural language processor 110. In this case, the metadata extractor 112 searches for content related to a restaurant that satisfies the condition “Near the user's current location” and the condition “Chinese restaurant” from the POI information 136 and further extracts metadata associated with the content from the POI information 136. The content is content handled in a POI homepage, a review (word-of-mouth) posting site, a reservation site, a Web geographic information system (GIS), and the like. For example, content related to a restaurant includes a food menu, a food price, a review, a photo, access information (for example, the presence or absence of a parking lot), business hours, and the like.

The metadata includes enough information for identifying the content of an attachment destination and is typically a document tag. The document tag is tag information for informing a web crawler or the like of information of a web page and may be a tag such as, for example, a hypertext markup language (HTML) meta-tag, or a title or a summary sentence of the web page. Also, the metadata may be a tag or a title added to a digital photo or a video file in addition to or instead of a document tag, or may be a review (word-of-mouth) document related to content. For example, in the Web GIS, in addition to location coordinates of the POI on the map, an access method for the POI, business hours, a menu, reviews (words-of-mouth) of an unspecified number of users, and the like may be provided together. When a map or an aerial photo associated with the location of the POI is ascertained as one piece of content, the metadata of the content will include the access method for the POI, business hours, a menu, reviews (words-of-mouth), and the like.

The importance level estimator 114 estimates an importance level of the user for each of a plurality of viewpoints included in the viewpoint list 134. The importance level is an index that quantitatively indicates a degree to which the user puts importance on each viewpoint. In other words, the importance level indicates how much the user is interested in each viewpoint. For example, the importance level estimator 114 may estimate an importance level for each viewpoint of the user on the basis of a surrounding environment of the user who has uttered the “request.” Further, the importance level estimator 114 may estimate the importance level for each viewpoint of the user on the basis of a result of feedback of the user notified of a “response” to the “request.”

The priority determiner 116 determines a priority of the metadata on the basis of an amount of information of the metadata extracted by the metadata extractor 112 and the importance level of the user for each viewpoint estimated by the importance level estimator 114.

The utterance information generator 118 selects metadata whose notification is to be preferentially provided from metadata of content extracted by the metadata extractor 112 on the basis of the priority of the metadata determined by the priority determiner 116 and generates utterance information using the selected metadata. The utterance information is speech data itself uttered by the voice user interface as the “response” to the “request” of the user or text data that becomes a source of the speech data.

The communication controller 120 transmits the utterance information generated by the utterance information generator 118 to the voice user interface (the device from which the “request” has been received between the communication terminal 300 and the agent device 500) via the communicator 102. Thereby, the user is notified of the metadata by means of an utterance.

Also, the communication controller 120 may transmit the content to which the metadata is attached to the voice user interface via the communicator 102 in addition to the utterance information for uttering the metadata.

### [Communication Terminal]

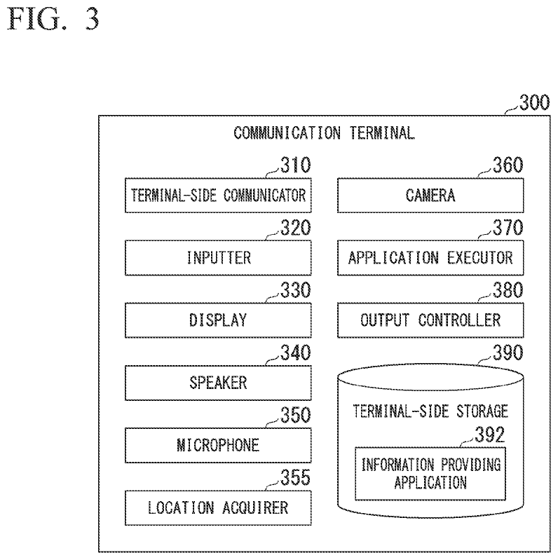

Next, a configuration of the communication terminal 300 will be described. FIG. 3 is a configuration diagram of the communication terminal 300 of the embodiment. The communication terminal 300 includes, for example, a terminal-side communicator 310, an inputter 320, a display 330, a speaker 340, a microphone 350, a location acquirer 355, a camera 360, an application executor 370, an output controller 380, and a terminal-side storage 390. The location acquirer 355, the application executor 370, and the output controller 380 are implemented by, for example, a hardware processor such as a CPU executing a program (software). Also, some or all of these components may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (a non-transitory storage medium) such as a DVD or a CD-ROM or may be installed in the storage device of the communication terminal 300 when the storage medium is mounted in a drive device, a card slot, or the like.

The terminal-side storage 390 may be implemented by the above-mentioned various types of storage devices, EEPROM, ROM, RAM, or the like. The terminal-side storage 390 stores, for example, the above-mentioned program, the information providing application 392, and various other types of information.

The terminal-side communicator 310 uses, for example, the network NW to communicate with the information providing device 100, the agent device 500, and other external devices.

The inputter 320 receives the input of the user U1 by operating, for example, various types of keys or buttons or the like. The display 330 is, for example, a liquid crystal display (LCD), an organic electro-luminescence (EL) display, or the like. The inputter 320 may be configured to be integrated with the display 330 as a touch panel. The display 330 displays various types of information in the embodiment according to the control of the output controller 380. For example, the speaker 340 outputs prescribed speech according to the control of the output controller 380. For example, the microphone 350 receives an input of speech of the user U1 according to the control of the output controller 380.

The location acquirer 355 acquires location information of the communication terminal 300. For example, the location acquirer 355 includes a global navigation satellite system (GNSS) receiver represented by a global positioning system (GPS) or the like. The location information may be, for example, two-dimensional map coordinates or latitude/longitude information. The location acquirer 355 may transmit the acquired location information to the information providing device 100 via the terminal-side communicator 310.

The camera 360 is, for example, a digital camera that uses a solid-state image sensor (an image sensor) such as a charge coupled device (CCD) or a complementary metal oxide semiconductor (CMOS). For example, when the communication terminal 300 is attached to an instrument panel of the vehicle M as a substitute for a navigation device or the like, the camera 360 of the communication terminal 300 may image a cabin of the vehicle M automatically or in accordance with the operation of the user U1.

The application executor 370 executes the information providing application 392 stored in the terminal-side storage 390. The information providing application 392 is an application program for controlling the output controller 380 so that an image (i.e., content) provided by the information providing device 100 is output to the display 330 and speech corresponding to the information (i.e., utterance information) provided by the information providing device 100 is output from the speaker 340. Also, the application executor 370 transmits the information input by the inputter 320 to the information providing device 100 via the terminal-side communicator 310. For example, the information providing application 392 may be downloaded from an external device via the network NW and installed in the communication terminal 300.

The output controller 380 causes the display 330 to display an image or causes the speaker 340 to output speech according to the control of the application executor 370. At that time, the output controller 380 may control content or a mode of the image to be displayed on the display 330 or may control content or a mode of the speech to be output to the speaker 340.

### [Vehicle]

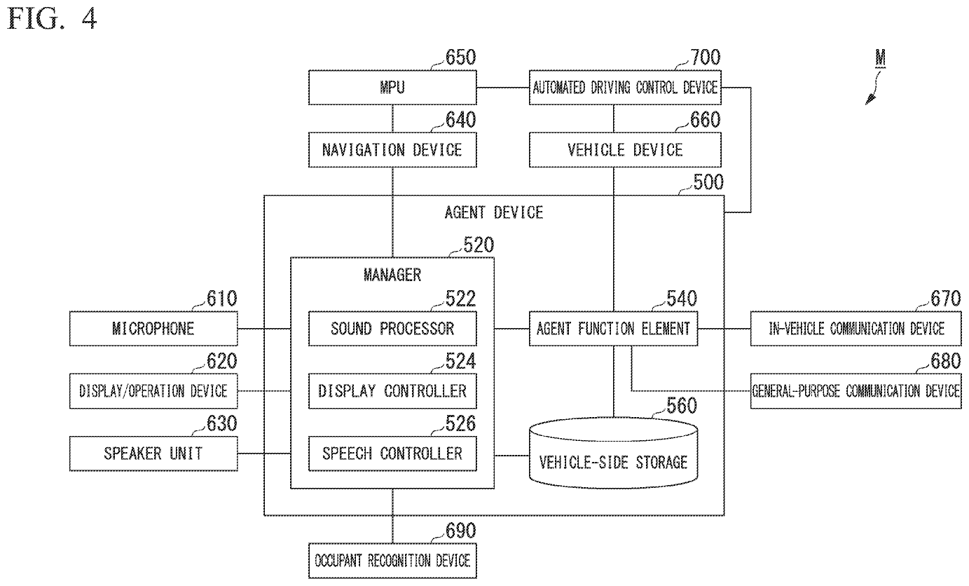

Next, a schematic configuration of the vehicle M in which the agent device 500 is mounted will be described. FIG. 4 is a diagram showing an example of a schematic configuration of the vehicle M in which the agent device 500 of the embodiment is mounted. As shown in FIG. 4, the vehicle M includes the agent device 500, a microphone 610, a display/operation device 620, a speaker unit 630, a navigation device 640, a map positioning unit (MPU) 650, a vehicle device 660, an in-vehicle communication device 670, an occupant recognition device 690, and an automated driving control device 700. A general-purpose communication device 680 such as a smartphone may be brought into a cabin and used as a communication device. The general-purpose communication device 680 is, for example, the communication terminal 300. These devices are connected to each other through a multiplex communication line such as a controller area network (CAN) communication line, a serial communication line, a wireless communication network, or the like.

First, a configuration other than the agent device 500 will be described. The microphone 610 is a sound collector that collects speech uttered within the cabin. The display/operation device 620 is a device (or a device group) capable of displaying an image and receiving an input operation. The display/operation device 620 is typically a touch panel. The display/operation device 620 may further include a head-up display (HUD) or a mechanical input device. The speaker unit 630 outputs, for example, speech, an alarm sound, or the like inside or outside of the vehicle. The display/operation device 620 may be shared by the agent device 500 and the navigation device 640.

The navigation device 640 includes a navigation human-machine interface (HMI), a positioning device such as a GPS, a storage device that stores map information, and a control device (a navigation controller) that performs a route search and the like. Some or all of the microphone 610, the display/operation device 620, and the speaker unit 630 may be used as the navigation HMI. The navigation device 640 searches for a route (a navigation route) for moving from the location of the vehicle M to a destination input by the user from the map information with reference to the map information on the basis of the location of the vehicle M identified by the positioning device and outputs guidance information using the navigation HMI so that the vehicle M can travel along the route. The route search function may be provided in the information providing device 100 or the navigation server that can be accessed via the network NW. In this case, the navigation device 640 acquires a route from the information providing device 100 or the navigation server and outputs guidance information. Also, the agent device 500 may be constructed on the basis of the navigation controller. In this case, the navigation controller and the agent device 500 are configured to be integrated on the hardware.

For example, the MPU 650 divides a route on the map provided from the navigation device 640 into a plurality of blocks (for example, divides the route every 100 [m] in a traveling direction of the vehicle) and determines a recommended lane for each block. For example, the MPU 650 determines what number lane the vehicle travels in from the left. Also, the MPU 650 may determine the recommended lane using map information (a higher-precision map) that is more precise than the map information stored in the storage device of the navigation device 640. The higher-precision map may be stored in, for example, the storage device of the MPU 650, or may be stored in the storage device of the navigation device 640 or the vehicle-side storage 560 of the agent device 500. The higher-precision map may include information about the center of the lane or information about the boundary of the lane, traffic regulation information, address information (address/postal code), facility information, telephone number information, and the like.

The vehicle device 660 is, for example, a camera, a radar device, a light detection and ranging (LIDAR) sensor, or a physical object recognition device. The camera is, for example, a digital camera using a solid-state imaging element such as a CCD or a CMOS. The camera is attached to any location on the vehicle M. The radar device radiates radio waves such as millimeter waves around the vehicle M and detects radio waves (reflected waves) reflected by a physical object to detect at least a location (a distance and a direction) of the physical object. The LIDAR sensor radiates light around the vehicle M and measures scattered light. The LIDAR sensor detects a distance to a target on the basis of a time period from light emission to light reception. The physical object recognition device performs sensor fusion processing on detection results of some or all of the camera, the radar device, and the LIDAR sensor, and recognizes a location, a type, a speed, and the like of a physical object near the vehicle M. The physical object recognition device outputs a recognition result to the agent device 500 and the automated driving control device 700.

The vehicle device 660 includes, for example, driving operators, a travel driving force output device, a brake device, a steering device, and the like. The driving operators include, for example, an accelerator pedal, a brake pedal, shift levers, a steering wheel, a variant steering wheel, a joystick, and other operators. A sensor for detecting the amount of operation or the presence or absence of operation is attached to the driving operator and a detection result is output to the agent device 500, the automated driving control device 700, or some or all of the travel driving force output device, the brake device, and the steering device. The travel driving force output device outputs a travel driving force (torque) for the vehicle M to travel to the drive wheels. The brake device includes, for example, a brake caliper, a cylinder that transfers hydraulic pressure to the brake caliper, an electric motor that generates hydraulic pressure in the cylinder, and a brake ECU. The brake ECU controls the electric motor in accordance with information input from the automated driving control device 700 or information input from the driving operator so that the brake torque according to the braking operation is output to each wheel. The steering device includes, for example, a steering ECU and an electric motor. For example, the electric motor changes a direction of steerable wheels by applying a force to a rack and pinion mechanism. The steering ECU drives the electric motor in accordance with the information input from the automated driving control device 700 or the information input from the driving operator to change the direction of the steerable wheels.

Also, the vehicle device 660 may include, for example, vehicle devices such as a door lock device, a door opening/closing device, a window, a window opening/closing device, a window opening/closing controller, a seat, a seat position controller, a rearview mirror, a rearview-mirror angle position controller, lighting devices inside and outside of the vehicle, a lighting device controller, a wiper, a defogger, a wiper or defogger controller, a direction indicator, a direction indicator controller, an air conditioner, and the like.

The in-vehicle communication device 670 is, for example, a wireless communication device that can access the network NW using a cellular network or a Wi-Fi network.

The occupant recognition device 690 includes, for example, a sitting sensor, a cabin camera, an image recognition device, and the like. The sitting sensor includes a pressure sensor provided on a lower part of a seat, a tension sensor attached to a seat belt, and the like. The cabin camera is a CCD camera or a CMOS camera installed in the cabin. The image recognition device analyzes an image of the cabin camera, recognizes the presence/absence of a user for each seat, a face of the user, and the like, and recognizes a sitting location of the user. Also, the occupant recognition device 690 may identify the user sitting in the driver's seat or a passenger seat or the like included in the image by performing a matching process associated with a facial image registered in advance.

The automated driving control device 700 performs a process, for example, when a hardware processor such as a CPU executes a program (software). Some or all of the components of the automated driving control device 700 may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory of the automated driving control device 700 or may be stored in a removable storage medium such as a DVD or a CD-ROM and installed in the HDD or the flash memory of the automated driving control device 700 when the storage medium (the non-transitory storage medium) is mounted in a drive device.

The automated driving control device 700 recognizes states of a location, a speed, acceleration, and the like of a physical object near the vehicle M on the basis of the information input via the physical object recognition device of the vehicle device 660. The automated driving control device 700 generates a future target trajectory along which the vehicle M automatically travels (independently of the driver's operation) so that the vehicle M can generally travel in the recommended lane determined by the MPU 650 and cope with a surrounding situation of the vehicle M. For example, the target trajectory includes a speed element. For example, the target trajectory is represented by sequentially arranging points (trajectory points) at which the vehicle M is required to arrive.

The automated driving control device 700 may set an automated driving event when a target trajectory is generated. Automated driving events include a constant-speed driving event, a low-speed tracking driving event, a lane change event, a branch-point-related event, a merge-point-related event, a takeover event, an automated parking event, and the like. The automated driving control device 700 generates a target trajectory according to an activated event. Also, the automated driving control device 700 controls the travel driving force output device, the brake device, and the steering device of the vehicle device 660 so that the vehicle M passes the generated target trajectory on time. For example, the automated driving control device 700 controls the travel driving force output device or the brake device on the basis of a speed element associated with a target trajectory (a trajectory point) or controls the steering device in accordance with a degree of curvature of the target trajectory.

Next, the agent device 500 will be described. The agent device 500 is a device that interacts with the occupant of the vehicle M. For example, the agent device 500 transmits an utterance of the occupant to the information providing device 100 and receives a response to the utterance from the information providing device 100. The agent device 500 presents the received response to the occupant using speech or an image.

The agent device 500 includes, for example, a manager 520, an agent function element 540, and a vehicle-side storage 560. The manager 520 includes, for example, a sound processor 522, a display controller 524, and a speech controller 526. In FIG. 4, the arrangement of these components is simply shown for the sake of description and, for example, the manager 520 may be actually interposed between the agent function element 540 and the vehicle-mounted communication device 60. The arrangement can be modified arbitrarily.

Each component other than the vehicle-side storage 560 of the agent device 500 is implemented by, for example, a hardware processor such as a CPU executing a program (software). Some or all of these components may be implemented by hardware (including a circuit; circuitry) such as an LSI circuit, an ASIC, an FPGA, or a GPU or may be implemented by software and hardware in cooperation. The program may be pre-stored in a storage device (a storage device including a non-transitory storage medium) such as an HDD or a flash memory or may be stored in a removable storage medium (the non-transitory storage medium) such as a DVD or a CD-ROM and installed when the storage medium is mounted in a drive device.

The vehicle-side storage 560 may be implemented by the above-mentioned various types of storage devices, EEPROM, ROM, RAM, or the like. The vehicle-side storage 560 stores, for example, programs and various other types of information.

The manager 520 functions by executing a program such as an operating system (OS) or middleware.

The sound processor 522 performs sound processing on an input sound so that the input sound is in a state suitable for recognizing information related to an inquiry, a request, or the like within various types of speech received from the occupant (for example, the user U2) of the vehicle M. Specifically, the sound processor 522 may perform sound processing such as noise removal.

The display controller 524 generates an image related to a response result for an inquiry or a request from the occupant of the vehicle M for an output device such as the display/operation device 620 in accordance with an instruction from the agent function element 540. The image related to the response result is, for example, an image showing a list of stores and facilities showing the response result for an inquiry, a request, or the like, an image related to each store or facility, an image showing a traveling route to a destination, other recommendation information, an image showing the start or end of a process, or the like. Also, the display controller 524 may generate an anthropomorphic character image (hereinafter referred to as an agent image) that communicates with the occupant in accordance with an instruction from the agent function element 540. The agent image is, for example, an image of a mode of talking to an occupant. The agent image may include, for example, a facial image, so that a facial expression or a facial orientation are recognized by at least a viewer (the occupant). The display controller 524 causes the display/operation device 620 to output the generated image.

The speech controller 526 causes some or all of the speakers included in the speaker unit 630 to output speech in accordance with an instruction from the agent function element 540. The speech includes, for example, speech for the agent image to have a dialogue with the occupant or speech corresponding to the image output to the display/operation device 620 by the display controller 524. Also, the speech controller 526 may perform control for localizing a sound image of agent speech at a position corresponding to a display position of the agent image using a plurality of speakers included in the speaker unit 630. The position corresponding to the display position of the agent image is, for example, a position where the occupant is expected to feel that the agent image is speaking the agent speech, and is, specifically, a position near the display position of the agent image (for example, within 2˜3 [cm]). Also, the localization of the sound image is, for example, a process of determining a spatial position of a sound source felt by the occupant by adjusting a volume of a sound that is transferred to the left and right ears of the user.

The agent function element 540 causes an agent image or the like to appear in cooperation with the information providing device 100 on the basis of various types of information acquired by the manager 520 and provides a service including a speech response in accordance with an utterance of the occupant of the vehicle M. For example, the agent function element 540 activates the agent on the basis of an activation word included in the speech processed by the sound processor 522 or ends the agent on the basis of an end word. Also, the agent function element 540 transmits speech data processed by the sound processor 522 to the information providing device 100 via the in-vehicle communication device 670 or provides information obtained from the information providing device 100 to the occupant. Also, the agent function element 540 may have a function of cooperating with the general-purpose communication device 680 and communicating with the information providing device 100. In this case, the agent function element 540 is paired with the general-purpose communication device 680 using, for example, Bluetooth (registered trademark) and the agent function element 540 is connected to the general-purpose communication device 680. Also, the agent function element 540 may be configured to be connected to the general-purpose communication device 680 according to wired communication using a universal serial bus (USB) or the like.

### [Processing Flow of Information Providing Device]

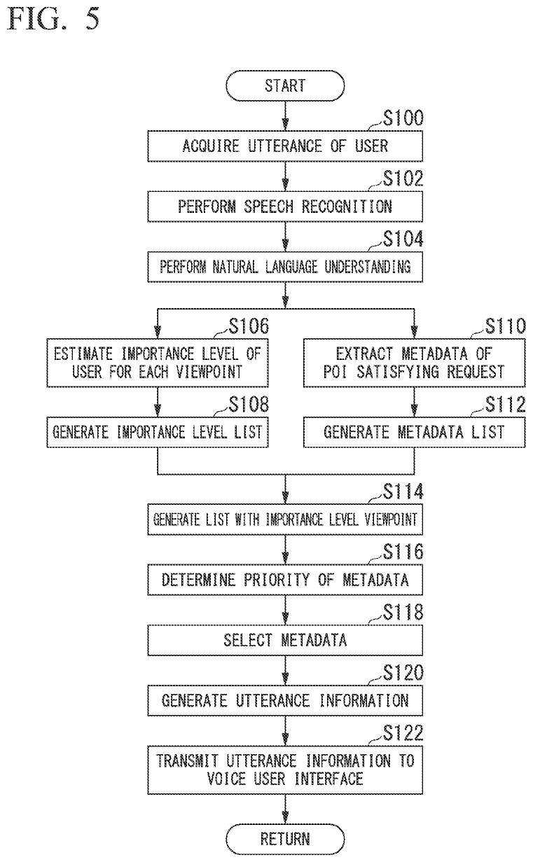

Next, the flow of a series of processing steps of the information providing device 100 will be described using a flowchart. FIG. 5 is a flowchart showing a flow of a series of processing steps of the information providing device 100 of the embodiment.

First, the acquirer 106 acquires an utterance of one user (hereinafter referred to as a target user) from the voice user interface (the communication terminal 300 or the agent device 500) via the communicator 102 (step S100). It is assumed that the target user is in the vehicle M and is moving.

Subsequently, the speech recognizer 108 performs speech recognition for the utterance of the target user and generates text data from the utterance of the target user (step S102). When the utterance is already textualized in the communication terminal 300 or the agent device 500, i.e., when the utterance of the target user acquired by the acquirer 106 is text data, the processing of S102 may be omitted.

Subsequently, the natural language processor 110 performs natural language understanding on the text data obtained from the utterance of the target user, and understands the meaning of the text data (step S104).

Subsequently, the importance level estimator 114 estimates an importance level of the target user for each of the plurality of viewpoints included in the viewpoint list 134 (step S106).

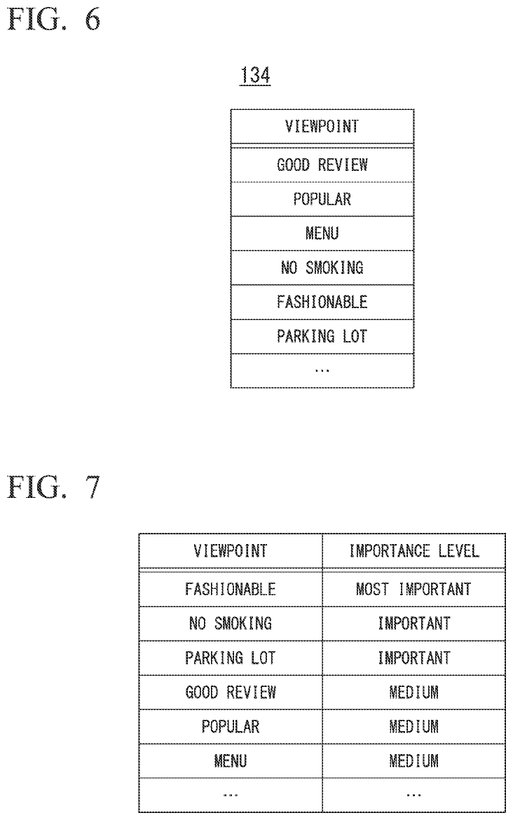

FIG. 6 is a diagram showing an example of the viewpoint list 134. As shown in FIG. 6, the viewpoint list 134 may include a plurality of viewpoints such as “good review,” “popular,” “menu,” “no smoking,” “fashionable,” and “parking lot.”

For example, the importance level estimator 114 estimates the importance level for each viewpoint of the target user on the basis of a surrounding environment of the target user at a time point of an utterance of the “request.” Specifically, the importance level estimator 114 may estimate the importance level on the basis of an environment at that time such as whether the target user has been in conversation, a speed or acceleration level of the vehicle M that is driven by the target user, or whether the vehicle M has been stopped or parked, at the time point of the utterance of the “request. Information indicating what type of environment the target user has been in at the time point of the utterance of the “request” may be stored in the storage 130.

Further, the importance level estimator 114 may estimate an importance level for each viewpoint of the target user on the basis of a result of feedback of the target user for the “response” when the “response” has been uttered from the voice user interface with respect to the “request” of the target user. Specifically, when some type of “proposal” or the like has been made from the voice user interface, the importance level estimator 114 may estimate the importance level on the basis of a feedback result of whether the target user has “accepted (selected)” the “proposal,” has “rejected” the “proposal,” or has “ignored” the “proposal” without doing anything. The feedback result of the target user at the time point of the utterance of such a “request” may be stored in the storage 130.

Further, the importance level estimator 114 may estimate the importance level on the basis of a trend of the feedback behavior of the target user in a certain population. Specifically, the importance level estimator 114 may estimate the importance level on the basis of a statistical probability of the feedback result of the target user with respect to the entire population.

When the importance level estimator 114 estimates the importance level for each viewpoint of the target user, the importance level estimator 114 generates an importance level list in which estimation results are listed (step S108).

FIG. 7 is a diagram showing an example of the importance level list. For example, the importance level estimator 114 may generate a list in which viewpoints are sorted in descending order from the viewpoint having the highest importance level of the target user among the plurality of viewpoints as the importance level list. The present invention is not limited to a case where importance levels are expressed by qualitative expressions such as “most important,” “important,” and “medium” in an example shown in FIG. 7 and the importance levels may be expressed by quantitative expressions such as “1.0,” “0.8,” and “0.5.”

Description returns to the flowchart of FIG. 5. Subsequently, when the natural language processor 110 understands that the target user's utterance is a “request,” the metadata extractor 112 extracts metadata of a POI satisfying the “request” from the POI information 136 (step S110).

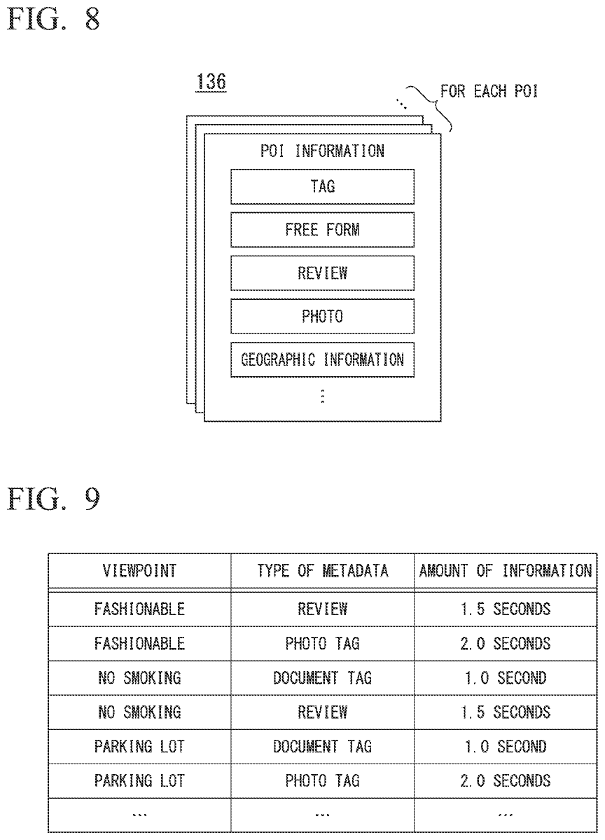

FIG. 8 is a diagram showing an example of the POI information 136. The POI information 136 is information in which a tag, a free form, a review, a photo, geographic information, and the like are associated with each POI. As described above, the tag may include a tag written in an HTML source or may include a tag that is automatically assigned using text mining or the like. Specifically, when the keyword “fashionable” has been frequently extracted from the POI reviews using text mining, the tag “fashionable” is automatically assigned to a POI that is a review target.

For example, the metadata extractor 112 selects a POI that satisfies the “request” of the target user from a plurality of POIs and further extracts information such as a tag associated with the selected POI as metadata.

Subsequently, the metadata extractor 112 generates a metadata list in which the extracted metadata is listed (step S112).

FIG. 9 is a diagram showing an example of a metadata list. The metadata extractor 112 extracts metadata for each of the plurality of viewpoints included in the viewpoint list 134. For example, it is assumed that there are two types of metadata of “review” and “photo tag” for one viewpoint of “fashionable.” In this case, the metadata extractor 112 may extract a plurality of different types of metadata with respect to the same viewpoint.

At this time, the metadata extractor 112 calculates or estimates an amount of information of the metadata. The metadata is a string written as a review or a tag. That is, the metadata basically includes text data. Accordingly, the metadata extractor 112 calculates or estimates a time period required to read text data included in the metadata by automatic speech as the amount of information of the metadata. As a length of the string of the review or the tag increases, the amount of information (the time period) increases.

When the amount of information of the metadata is calculated or estimated, the metadata extractor 112 generates a list associated with the type of metadata and the amount of information with respect to each viewpoint as a metadata list.

Description returns to the flowchart of FIG. 5. Subsequently, the priority determiner 116 generates a list with an importance level viewpoint in which the importance level list generated by the importance level estimator 114 and the metadata list generated by the metadata extractor 112 are combined (step S114).

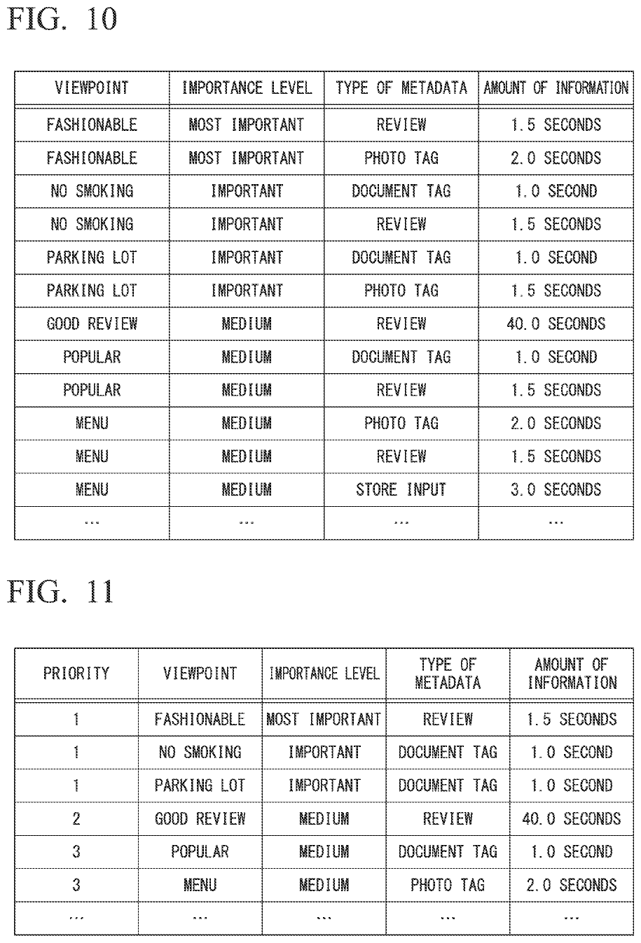

FIG. 10 is a diagram showing an example of a list with an importance level viewpoint. The list with the importance level viewpoint is a list in which an importance level of the target user, a type of metadata, and an amount of information of the metadata are associated with each viewpoint.

Description returns to the flowchart of FIG. 5. Subsequently, the priority determiner 116 determines priority of metadata included in the list with the importance level viewpoint (step S116).

For example, the priority determiner 116 determines priority of metadata so that the reading of the text data included in metadata is completed within the period until the target user reaches the POI that satisfies the “request” of the target user.

For example, it is assumed that the target user makes the utterance “Find a nearby Chinese restaurant” as the “request” with respect to a voice user interface and the POI satisfying this “request” is “restaurant B.” In this case, the priority determiner 116 assumes that a speed of the vehicle M into which the target user has gotten is uniform and calculates a time period (a traveling time period) required for traveling in a section from a location where the “request” has been uttered to a location of “restaurant B.” When the vehicle M has already passed “restaurant B,” the priority determiner 116 may calculate a time period for traveling to the nearest U-turn point where it is possible to return to “restaurant B.” The priority determiner 116 increases the priority of the metadata for which the reading of the automatic speech can be completed within the calculated traveling time period from among the plurality of pieces of metadata included in the list with the importance level viewpoint.

FIG. 11 is a diagram showing an example of the priority of metadata. As shown in FIG. 11, the priority determiner 116 assigns the highest priority to metadata of a viewpoint whose importance level of the target user is the “most important” level, assigns the next highest priority to metadata of a viewpoint whose importance level of the target user is the next highest level after the “most important” level (i.e., a viewpoint of the “important” level), and assigns the next highest priority to metadata of a viewpoint whose importance level of the target user is the next highest level after the “important” level (i.e., a viewpoint of the “medium” level).

At this time, when a plurality of pieces of metadata are associated with the same viewpoint, the priority determiner 116 raises the priority of the metadata having the smallest amount of information among the plurality of pieces of metadata. In the list with the importance level viewpoint in FIG. 10, two types of metadata of “review” and “photo tag” are associated with the viewpoint of “fashionable” whose importance level of the target user is the “most important” level and two types of metadata of “document tag” and “review” are associated with the viewpoint of “no smoking” whose importance level of the target user is the “important” level. In this case, the priority determiner 116 raises the priority of the metadata of “review” having a smaller amount of information with respect to the viewpoint of “fashionable” and raises the priority of the metadata of “document tag” having a smaller amount of information with respect to the viewpoint of “no smoking.” The priority of the metadata of “photo tag” or the metadata of “document tag” having a large amount of information may be lowered to the lowest level or the like so that the metadata does not overlap at the same viewpoint. As described above, the priority determiner 116 raises the priority of the metadata for which the importance level of the user is high and the amount of information is small among a plurality of pieces of metadata included in the list with the importance level viewpoint.

Also, the priority determiner 116 may raise the priority of the metadata having a large amount of information as the driving load on the target user decreases and lower the priority of the metadata having a large amount of information as the driving load on the target user increases. More specifically, the priority determiner 116 may lower the priority of the metadata to the lowest level or the like regardless of the importance level when the driving load on the target user is greater than or equal to a prescribed value even with respect to metadata associated with a viewpoint whose importance level of the target user is high. Also, the priority determiner 116 may raise the priority of the metadata whose amount of information is large under an automated driving mode in which the driving load on the target user becomes light as compared with a manual driving mode in which the driving load on the target user becomes heavy. In this way, it is possible to notify the target user of useful POI information while limiting the occurrence of driver distraction by determining the priority of the metadata in consideration of the driving load on the target user.

Description returns to the flowchart of FIG. 5. Subsequently, the utterance information generator 118 selects metadata whose notification is to be preferentially provided to the target user from metadata included in the list with the importance level viewpoint on the basis of the priority of the metadata determined by the priority determiner 116 (step S118).

For example, the utterance information generator 118 performs an addition operation on an amount of information of the metadata in order from the one with the highest priority and selects metadata so that a total amount of information (i.e., a total time period) does not exceed a time period until the target user reaches a POI satisfying the “request.” For example, in the example of FIG. 11, metadata from the top metadata to the third metadata is selected when a time period required for the arrival at the POI satisfying the “request” is 10 seconds and metadata from the top metadata to the fourth metadata is selected when a time period required for the arrival at the POI satisfying the “request” is 45 seconds.

Also, the utterance information generator 118 may calculate a time period during which the target user can easily receive information in a section to the POI (i.e., a temporary destination) that satisfies the “request” and select metadata so that the reading of text data included in metadata is completed within the time period. The “time period during which the target user can easily receive information” is, for example, a time period during which the vehicle M is stopped at a traffic light, a time period during which the vehicle M is traveling under a given speed due to an influence of traffic congestion, or the like. That is, the utterance information generator 118 may calculate a time period during which the driving load on the target user is relatively reduced under manual driving and select metadata so that the reading of text data is completed within the time period. Thereby, for example, even if the time period required for the arrival at the POI satisfying the “request” is 45 seconds, when the time period during which the driving load on the target user is relatively reduced is only 10 seconds, only metadata from the top metadata to the third metadata will be selected and the fourth and subsequent metadata will be excluded in the example of FIG. 11.

Also, the utterance information generator 118 may select a large number of pieces of metadata when the vehicle M into which the target user has gotten is under the automated driving mode as compared with when the vehicle M is under the manual driving mode. Thereby, under the automated driving mode in which the driving load on the target user is relatively low, the target user can be notified of more useful POI information.

Next, the utterance information generator 118 generates utterance information using the selected metadata (step S120). For example, the utterance information generator 118 may generate a “response sentence” for the “request” of the target user on the basis of the utterance template 138.

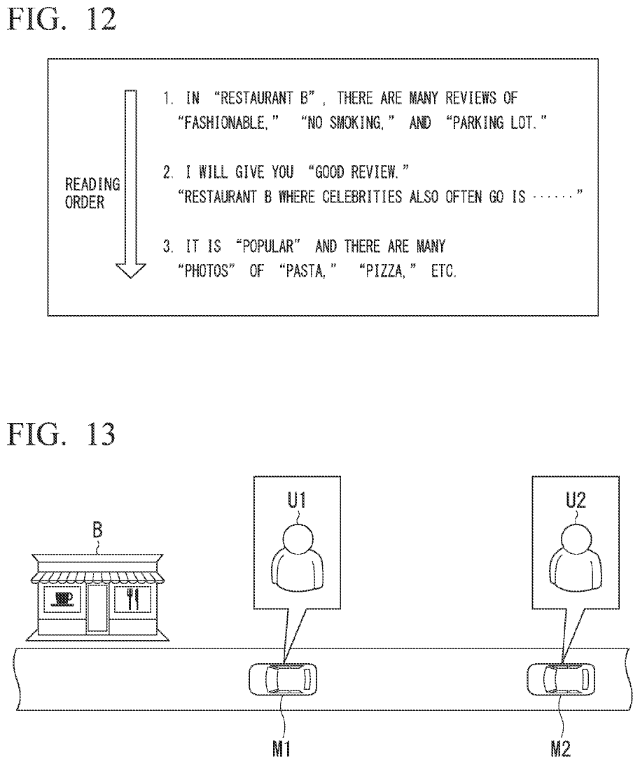

FIG. 12 is a diagram showing an example of a response sentence. As shown in FIG. 12, metadata of the same priority is summarized into one response sentence. For example, it is assumed that all metadata in FIG. 11 has been selected. Within the metadata, the priority of the metadata from the viewpoints of “fashionable,” “no smoking,” and “parking lot” is the first priority. In this case, if the POI that satisfies the “request” is “restaurant B,” a first response sentence in which the proper noun “restaurant B” is the subject and which indicates that there are many reviews of “fashionable,” “no smoking,” and “parking lot” and the like is generated. Further, in the example of FIG. 11, the priority of the metadata from the viewpoint of a “good review” is the second priority. In this case, the “good review” itself is generated as a second response sentence. Further, in the example of FIG. 11, the priority of the metadata from the viewpoints of “popular” and “menu” is the third priority. In this case, as a sentence in which the proper noun “restaurant B” is indicated as the subject, a third response sentence indicating that restaurant B is “popular” and provides the photos of “pasta” and “pizza” is generated. These three response sentences are read in order of priority of metadata, i.e., in order of the first response sentence, the second response sentence, and the third response sentence.

Further, the utterance information generator 118 may synthesize artificial speech on the basis of the generated response sentence. For example, the utterance information generator 118 converts a string included in the response sentence into phonetic symbols and synthesizes speech that reads the phonetic symbols using waveform concatenative speech synthesis (concatenative synthesis) or formant synthesis.

Description returns to the flowchart of FIG. 5. Subsequently, the communication controller 120 transmits utterance information generated by the utterance information generator 118, i.e., a response sentence or synthesized speech, to the voice user interface via the communicator 102 (step S122).

At this time, when the vehicle M into which the target user gets is under the automated driving mode, the communication controller 120 may transmit content (for example, a photo, a map, or the like) that is an attachment destination of metadata to the voice user interface in addition to the response sentence or the synthesized speech generated by the utterance information generator 118. Thereby, the process of the present flowchart ends.

For example, when a response sentence has been received from the information providing device 100, the voice user interface synthesizes speech that reads the response sentence and outputs the synthesized speech as an utterance. When the voice user interface is the communication terminal 300, the application executor 370 synthesizes the speech that reads the response sentence and the output controller 380 causes the speaker 340 to output the speech synthesized by the application executor 370. When the voice user interface is the agent device 500, the agent function element 540 synthesizes the speech that reads the response sentence and the speech controller 526 causes the speaker unit 630 to output the speech synthesized by the agent function element 540. When the voice user interface receives the synthesized speech instead of receiving the response sentence from the information providing device 100, the synthesized speech is output as an utterance.

Also, when the voice user interface receives the response sentence or the synthesized speech from the information providing device 100 and also receives the content of the attachment destination of the metadata, the content may be displayed on the display. [Example of scene]

Hereinafter, a scene to which technology of the present embodiment is applied will be described. FIG. 13 is an example of the scene to which the technology of the present embodiment is applied. In FIG. 13, B denotes a certain restaurant, M1 denotes a vehicle into which the user U1 gets, and M2 denotes a vehicle into which the user U2 gets. In the scene shown in FIG. 13, the vehicle M1 is closer to restaurant B than the vehicle M2. In such a positional relationship, it is assumed that both the users U1 and U2 put importance on the same viewpoint and further ask the voice user interface about “restaurant B” (i.e., send a request for information about “restaurant B” thereto). In this case, an amount of information of “restaurant B” provided to the user U1 is smaller than the amount of information of “restaurant B” provided to the user U2.

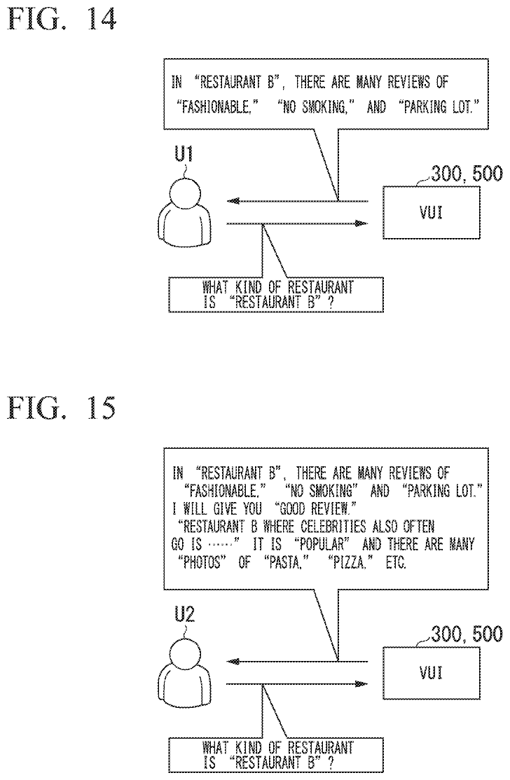

FIG. 14 is a diagram showing an example of information provided to the user U1 and FIG. 15 is a diagram showing an example of information provided to the user U2. For example, it is assumed that a time period required for the vehicle M1 to reach restaurant B is about 10 seconds and a time period required for the vehicle M2 to reach restaurant B is about 45 seconds. In this case, the voice user interface of the user U1 reads only the first response sentence by automatic speech and the voice user interface of the user U2 reads the first response sentence, the second response sentence, and the third response sentence by automatic speech. In this way, by changing an amount of POI information or its type for each user, it is possible to improve the user's satisfaction and improve the convenience of the voice user interface.

According to the embodiment described above, the information providing device 100 determines the priority of the metadata on the basis of an importance level indicating a degree to which the user puts importance on each of the plurality of POIs (an example of content) and an amount of information of the metadata that is attached to each of the plurality of POIs. The information providing device 100 generates a description sentence for the POI into which the metadata is combined as a response sentence on the basis of the determined priority of the metadata and transmits the response sentence to the voice user interface. In response to this, the voice user interface reads the description sentence for the POI by automatic speech. In this way, the amount of information for the POI and/or its type can be changed for each user in accordance with the importance level of the user and/or the amount of information of the metadata. As a result, information to be provided to the user in a notification via the voice user interface can be adjusted to an amount of information suitable for each user.

Further, according to the above-described embodiment, the priority of the metadata is determined on the basis of the driving load on the user, so that the user can accept the information without psychological burden. The psychological burden is, for example, a burden related to the driver's recognition, determination, or operation (including a response by an utterance) with respect to the utterance content of the voice user interface.

### OTHER EMBODIMENTS

Hereinafter, other embodiments will be described. Although the case where the importance level estimator 114 estimates the importance level of the user for each of the plurality of viewpoints included in the viewpoint list 134 has been described in the above-described embodiment, the present invention is not limited thereto. For example, the user may input the importance level in advance using the communication terminal 300.

Although the case where the information providing device 100 and the voice user interface (the communication terminal 300 or the agent device 500) are separate devices have been described in the above-described embodiment, the present invention is not limited thereto. For example, the voice user interface may include functional components of the information providing device 100.

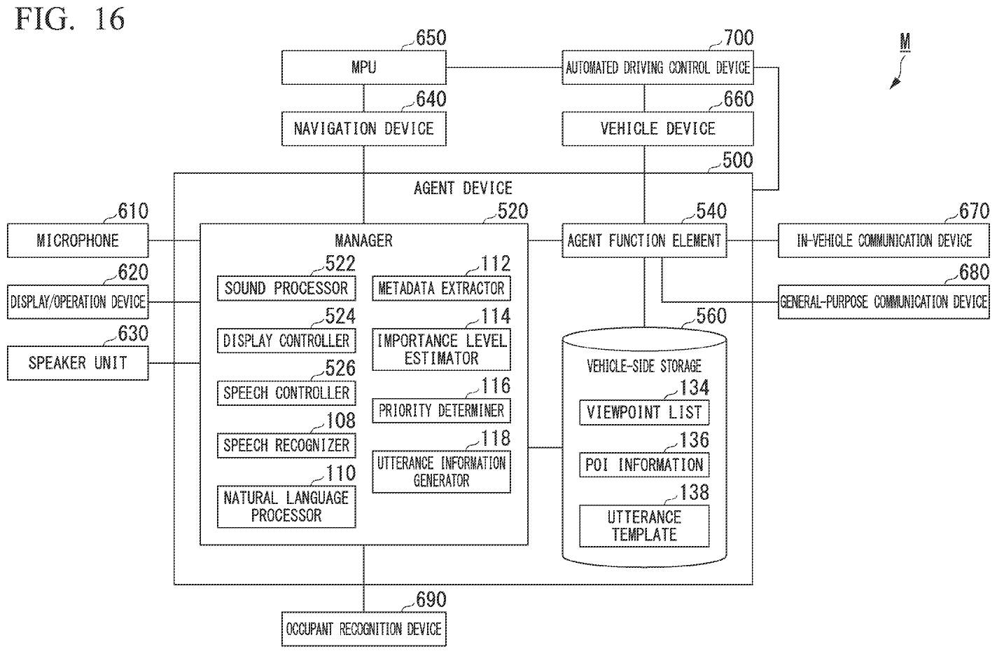

FIG. 16 is a diagram showing another example of the schematic configuration of the vehicle M in which the agent device 500 of the embodiment is mounted. As shown in FIG. 16, the manager 520 of the agent device 500 may further include functional components of the information providing device 100 such as a speech recognizer 108, a natural language processor 110, a metadata extractor 112, an importance level estimator 114, a priority determiner 116, and an utterance information generator 118. Also, the viewpoint list 134, the POI information 136, the utterance template 138, and the like may be further stored in the vehicle-side storage 560. In such a configuration, the agent device 500 is another example of the “information processing device.”

The embodiment described above can be represented as follows.

An information processing device including:

a memory storing a program; and

a processor,

wherein the processor executes the program to:

determine priority of metadata on the basis of an importance level indicating a degree of importance a user to each of a plurality of pieces of content and an amount of information of the metadata that is attached to each of the plurality of pieces of content; and

notify the user of the metadata on the basis of the determined priority.

Although modes for carrying out the present invention have been described using embodiments, the present invention is not limited to the embodiments, and various modifications and substitutions can also be made without departing from the scope and spirit of the present invention.

What is claimed is:

1. An information processing device comprising:
a determiner configured to determine priority of metadata on the basis of an importance level indicating a degree of importance for a user to each of a plurality of pieces of content and an amount of information of the metadata that is attached to each of the plurality of pieces of content; and
a notifier configured to notify the user of the metadata on the basis of the priority determined by the determiner.

2. The information processing device according to claim 1, further comprising:
an acquirer configured to acquire a request from an utterance of the user; and
an extractor configured to extract the metadata from one or more pieces of the content satisfying the request acquired by the acquirer,
wherein the determiner determines the priority of the metadata on the basis of an amount of information of the metadata extracted by the extractor and the importance level of the content to which the metadata extracted by the extractor is attached, and
wherein the notifier notifies the user of the metadata as a response to the request on the basis of the priority.

3. The information processing device according to claim 2, further comprising an estimator configured to estimate the importance level on the basis of a surrounding environment of the user when the user makes an utterance of the request.

4. The information processing device according to claim 3, wherein the estimator further estimates the importance level on the basis of a result of feedback of the user provided in response to a notification of the metadata.

5. The information processing device according to claim 1,
wherein the metadata comprises text, and
wherein the notifier notifies the user of the metadata by reading the text comprised in the metadata by automatic speech.

6. The information processing device according to claim 5, wherein the determiner determines the priority of the metadata so that the reading of the text is completed within a period until the user reaches a destination.

7. The information processing device according to claim 1, wherein the determiner raises the priority of the metadata for which the importance level for the content of an attachment destination is high and the amount of information is small.

8. The information processing device according to claim 1,
wherein the user is a driver who drives a vehicle, and
wherein the determiner further determines the priority of the metadata on the basis of a driving load on the driver.

9. The information processing device according to claim 8, wherein the determiner lowers the priority of the metadata whose amount of information increases as the driving load on the driver increases.

10. The information processing device according to claim 8, wherein the notifier notifies the user of more metadata when the vehicle is under an automated driving mode as compared with when the vehicle is under a manual driving mode.

11. The information processing device according to claim 8, wherein the notifier further notifies the user of the content when the vehicle is under an automated driving mode.

12. An information processing method comprising:
determining, by a computer, priority of metadata on the basis of an importance level indicating a degree of importance a user to each of a plurality of pieces of content and an amount of information of the metadata that is attached to each of the plurality of pieces of content; and
notifying, by the computer, the user of the metadata on the basis of the determined priority.

13. A computer-readable non-transitory storage medium storing a program for causing a computer to:
determine priority of metadata on the basis of an importance level indicating a degree of importance a user to each of a plurality of pieces of content and an amount of information of the metadata that is attached to each of the plurality of pieces of content; and
notify the user of the metadata on the basis of the determined priority.
